(19) United States
(12) Patent Application Publication
(10) Pub. No.: US 2018/0345176 A1
(43) Pub. Date: Dec. 6, 2018

(54) SUBSEA OIL STORAGE TANK PRE-SEPARATION

(71) Applicant: SEACAPTAUR IP LTD, Osborne Park, Western Australia (AU)

(72) Inventor: Alan Roberts, Leederville, Western Australia (AU)

(21) Appl. No.: 15/776,498

(22) PCT Filed: Nov. 16, 2016
(86) PCT No.: PCT/AU2016/051105

§ 371 Date: May 16, 2018

(30) Foreign Application Priority Data
Nov. 16, 2015 (AU) 2015904723

(51) Int. Cl. B01D 19/00; E21B 43/36; B01D 17/02; B65D 88/78; C02F 1/40

(52) U.S. Cl. CPC B01D 19/0036; E21B 43/36; B01D 19/0063; C02F 2101/32; B65D 88/78; C02F 1/40; B01D 17/0214

(57) ABSTRACT

A subsea oil over water storage tank, having one or multiple of high dynamic range, gas-liquid separators, which first receive oil well fluids, and cyclically depressurize and release free and solution gas to surface, and then expel unseparated liquids to the subsea storage tank, where the oil and water may be further separated by gravity separation, providing a means of separating stabilising crude oil.

### TECHNICAL FIELD

The present invention relates to separation and storage of crude oil subsea.

The present invention has been devised particularly but not necessarily solely in relation to a subsea crude oil storage tank, which in combination with other devices, allows it to act as a primary oil-gas-water separation facility, as well as a crude oil storage facility.

### BACKGROUND ART

The following discussion of the background art is intended to facilitate an understanding of the present invention only. The discussion is not an acknowledgement or admission that any of the material referred to is or was part of the common general knowledge as at the priority date of the application.

For more than a century, the onshore oil and gas industry has employed a method of three phase (oil-gas-water) oil well fluid separation, known as “stock tank separation” or “gun barrel separation”. Such separation occurs entirely at ambient temperatures and pressures, within a field storage tank.

Oil well fluids are generally unstable, when released to the atmosphere, due to the explosive release of gas in solution in the oil, sometimes termed a flash reaction.

The essential feature of stock tank separation is a large tank, containing or having externally mounted a vessel (gun barrel), where initial flash reaction and separation occurs, with limited disturbance to settling and separation of oil and water occurring inside the storage tank.

If too explosive, the oil well fluids have to first go to a pressure vessel, generally termed a first stage separator, and sometimes to second and third stage separator until a stable crude oil emerges. Under such circumstances, the field storage tank acts as a storage facility only, with all separation occurring entirely inside the first-second-third stage pressure vessels.

If a storage tank is placed subsea, the ambient conditions are entirely different. At 100 meter water depth, the ambient pressure is 10 atmospheres or 142 psi, and the tank is able to handle far more elevated flash conditions. However, the disturbance issues still have to be addressed, and gas has to be removed due to the subsea setting, by means of some form separate gun barrel type device.

### SUMMARY OF INVENTION

According to a first aspect of the invention there is provided a subsea oil storage pre-separation system for processing of well fluids comprising a mixture of oil, gas and water, the system comprising a tank having an inner space and at least one primary separator fluidly connected to the tank to permit the mixture of oil and water to enter the tank, wherein the tank comprises a flume having an inlet for receiving the water and oil mixture, a first end with first outlet means to allow exit of oil (from the oil-water mixture), and a second end with second outlet means to allow exit of water from the oil-water mixture.

Preferably, the flume is located in the centre of tank such that the second end is located at the bottom of the tank.

Preferably, the flume extends perpendicularly from the bottom of the tank so that the first end is located at a location adjacent an upper wall of the tank.

Preferably, the inlet is located adjacent the second end.

Preferably, the flume comprises a cylindrical body having first outlet means configured as a plurality of apertures surrounding the cylindrical body at the upper end, and having second outlet means configured as a plurality of apertures surrounding the cylindrical body at the lower end.

Preferably, the separator is fluidly connected to the tank via a pipe comprising a one-way valve.

Preferably, the separator is adapted to produce a pre-separation of the gas included in the well fluids exiting wells fluidly connected to the separator.

Preferably, the separator comprises a large dynamic range over which the gas-liquid interface travels within the separator.

Preferably, the dynamic range is about 10 meters or more.

Preferably, the separator comprises upper and lower level indicators.

Preferably, the separator comprises an outlet for permitting exit of gas included in the well fluids.

Preferably, a first pipe is fluidly connected to the outlet for delivering the gas to reach the atmosphere.

Preferable the first pipe comprises valve means.

Preferably, the separator comprises an inner pipe extending from a lower end of the separator, one end of the inner pipe comprises an outlet for well fluids to enter the separator.

Preferably, the other end of the inner pipe is located outside the separator being fluidly connected to one or more wells.

Preferably, a first control valve is located within the flow path of the inner pipe to permit controlling well fluids to enter the separator.

Preferably, the pipe is configured so that the outlet is located at the upper end of the dynamic range of the separator.

In a particular arrangement there is provided a plurality of separators arranged and fluidly connected in a tandem relationship with respect each other.

According to a second aspect of the invention there is provided a subsea oil storage pre-separation system for processing of well fluids comprising a mixture of oil, gas and water, the system comprising a tank having an inner space and at least one primary separator fluidly connected to the tank to permit the mixture of oil and water to enter the tank, wherein the separator comprises upper and lower level indicators defining a dynamic range over which the gas-liquid interface may travel within the separator.

Preferably, the separator is fluidly connected to the tank via a second pipe comprising a one-way valve.

Preferably, the separator is adapted to produce a pre-separation of the gas included in the well fluid exiting the wells.

Preferably, the separator comprises a large dynamic range, meaning the range over which the gas-liquid interface may travel within the separator.

Preferably, the dynamic range is about 10 meters or more.

Preferably, the separator comprises an outlet for permitting exit of gas of the well fluids.

Preferably, a first pipe is fluidly connected to the outlet for delivering the gas to reach the atmosphere.

Preferably, the first pipe comprises valve means.

Preferably, the separator comprises an inner pipe extending from a lower end of the separator, one end of the inner pipe comprises an outlet for well fluids to enter the separator.

Preferably, the other end of the inner pipe is located outside the separator being fluidly connected to one or more wells.

Preferably, a first control valve is located within the flow path of the inner pipe to permit controlling well fluids to enter the separator.

Preferably, the inner pipe is configured so that the outlet is located at the upper end of the dynamic range of the separator.

Preferably, the tank comprises a tank in accordance with a first aspect of the invention.

According to a third aspect of the invention there is provided a subsea oil over water storage tank, having one or multiple of high dynamic range, gas-liquid separators, which first receive oil well fluids, and cyclically depressurize and release free and solution gas to surface, and then expel unseparated liquids to the subsea storage tank, where the oil and water may be further separated by gravity separation, providing a means of separating stabilising crude oil.

According to a fourth aspect of the invention there is provided a subsea separation and storage system having a tank as described in the first aspect of the invention, providing a means of stabilising crude oil to a vapour pressure necessary to transport at surface, even though the operation takes place in a hyperbaric subsea setting.

Preferably, the subsea separation and storage system may be made to be a continuous flow system, as opposed to a cyclic flow system, if two or more high dynamic range gas liquid separators are employed and sequenced so one in ingesting well fluids while the other is expelling degassed fluids.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a schematic view of a particular arrangement of a subsea oil storage pre-separation system in accordance with an embodiment of the invention.

### DESCRIPTION OF EMBODIMENTS

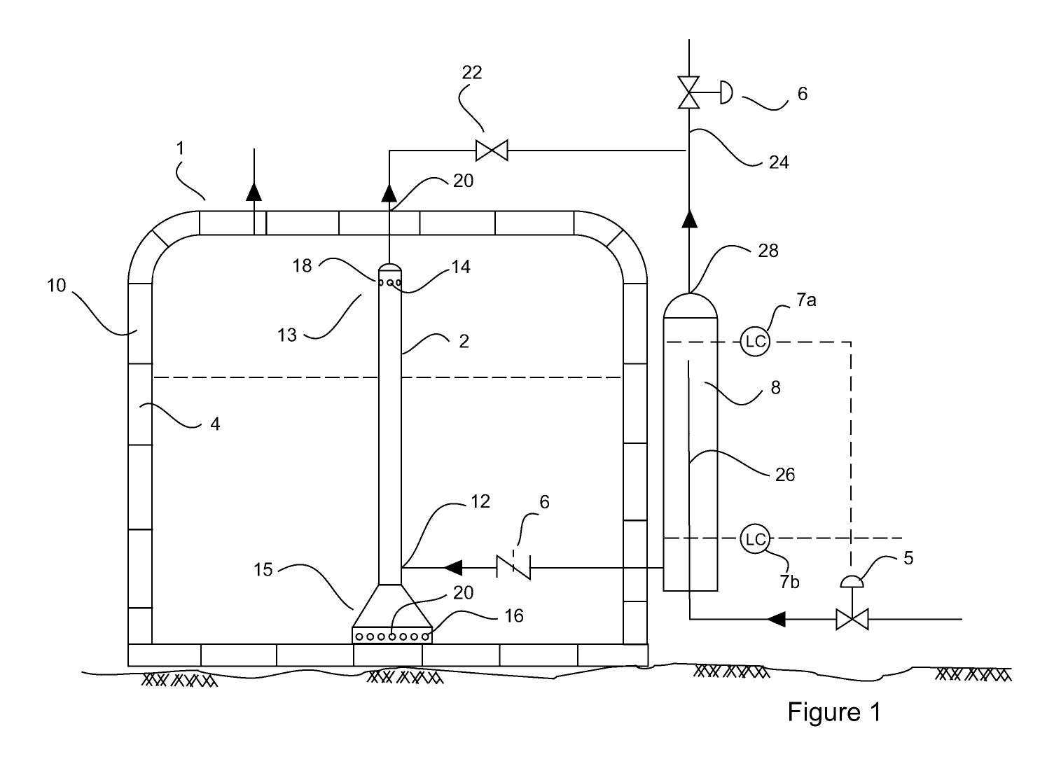

FIG. 1 show a particular arrangement of a subsea oil storage pre-separation system in accordance with an embodiment of the invention.

The system comprises a tank 1 and a primary separator 3 fluidly connected to the tank 1 to permit a mixture of oil and water to enter the tank. The tank 1 is an “oil over water” tank. As produced oil and water is introduced, oil floats to the top displacing ballast and produced seawater, until filled.

The tank 1 comprises a body 10 having bottom, upper and side walls for defining an inner space.

Further, the tank 1 comprises a flume 2 having an inlet for receiving the water and oil mixture. The flume 2 comprises also a first end 15 with first outlet means 14 to allow exit of oil (from the oil-water mixture), and a second end 15 with second outlet means 16 to allow exit of water from the oil-water mixture.

In the particular arrangement shown in the figures, the flume 2 is located in the centre of tank 1 such that the second end 15 is located at the bottom of the tank 1. The flume 2 extends perpendicularly from the bottom of the tank 1 so that the first end 13 is located at location adjacent the upper wall of the tank 10. In this particular arrangement, the inlet 12 is located adjacent the second end 15. As will be described later, the inlet 12 permits delivery of the oil and water mixture into the flume 2 for separation of the mixture of oil and gas. The water flows into the inner space of the tank 1 via the second outlet means 16; the oil flows into the inner space of the tank 1 via the first outlet means 14.

Further, as shown in FIG. 1, the flume 2 comprises a cylindrical body having first outlet means 14 configured as a plurality of apertures 18 surrounding the cylindrical body at the upper end 13, and having second outlet means 16 configured as a plurality of apertures 20 surrounding the cylindrical body at the lower end 15.

Further, as mentioned before, the subsea oil storage pre-separation system in accordance with an embodiment of the invention comprises a primary separator 3 that is fluidly attached to the tank 1 for delivery of the oil and water mixture exiting the primary separator 3. In alternative arrangements there may be provided a plurality of separators 3 arranged in tandem relationship with respect to each other.

The separator 3 is adapted to produce a pre-separation of the gas included in the well fluid exiting the wells. In accordance with an arrangement this separator 3 has a large dynamic range, meaning the range over which the gas-liquid interface may travel within the separator 3.

The separator 3 comprises level indicators 7a and 7b. In FIG. 1, the devices labelled LC are level controllers; the dynamic range is the distance the gas-liquid interface may travel between the two level controllers. In a particular arrangement, the dynamic range be more of the order to 10 meters this is a factor of 33 greater than conventional onshore first stage separators that normally operates within a dynamic range of 0.3 m.

Further, the separator 3 comprises an outlet for permitting exit of gas of the well fluids. A pipe 24 is fluidly connected to the outlet for delivering the gas to reach the atmosphere.

Furthermore, the separator 3 comprises an inner pipe 26 extending from a lower end of the separator 3. The end of the inner pipe 26 included in the separator 3 comprises an outlet 8 for well fluids to enter the separator 3; the end of the pipe 26 located outside the separator 3 is fluidly connected to one or more wells. A control valve 5 is located within flow path of the pipe 26 to permit controlling well fluids to enter the separator.

The pipe 26 is configured so that the outlet 8 is located at the upper end of the dynamic range of the separator 3.

Below will be described the process of operation of the subsea oil storage pre-separation system in accordance with an embodiment of the invention.

Oil well fluids are introduced into the primary separator 3, by opening control valve 5 and the pressure within the separator is reduced in the separator 3 by opening control valve 6 to permit the oil/water mixture flow into the separator. The gas of the well fluid is released to atmosphere via outlet 28 and pipe 24. The valve 6 is a one-way check valve to prevent the oil-water mixture to re-enter the separator 3. The well fluids are admitted until the separator until filled up to the upper level controller 7a.

The de-gassed liquids are then squeezed out of the primary separator 3, by closing control value 6, and opening control valve 5, and so long as the outlet 8 is high in the dynamic range, already destabilised fluids will be expelled to the tank preferentially to the incoming not de-gassed fluids, so long as the dead space, below the lower level controller, is appropriately sized, so as to be larger than the new incoming fluid charge.

If the primary separator is 2 meter in diameter and the dynamic range is 10 meter, the amount of fluid which may be processed in one batch is approximately 200 barrels, If the residence time of the fluids for each batch is 15 minutes, 96 batches of crude may be separated for day, or production rate of 19,200 BPD (barrels per day).

However, three issues emerge: (a) Time is required to expel the stabilised crude and receive a new batch of well fluids; (b) Not all the fluids are oil, a significant percentage is normally water; and (c) it is often detrimental to oil well performance, to drawn off fluids intermittently.

Issue (a) and issue (c) mentioned above may be solved by operating two separators 3 in tandem, one expel and receive fluids mode, while the other is in gas vent mode, whereby the process becomes continuous, as opposed to cyclic.

Issue (b) mentioned above may be resolved by manipulating the volumetric capacity on the primary separator(s) or adding more separators, until the required oil flow rate is achieved.

The unseparated oil and water mixture is introduced into the flume 2 of the tank 1, for pre-separation, with oil migrating to the top and water to the bottom of the tanks.

Any gas present in the flume 2 may be delivered to the atmosphere via pipe 24. As shown in FIG. 1, the tank 10 may be include a port 20 allowing gas to exit the second end 13 of the flume 2 and delivery to the pipes 24 for allowing the gas to flow to the atmosphere. A valve means 22 is provided to impede gas exiting the primary separator 3 to enter the fume via port 20.

Throughout this specification, unless the context requires otherwise, the word “comprise” or variations such as “comprises” or “comprising”, will be understood to imply the inclusion of a stated integer or group of integers but not the exclusion of any other integer or group of integers

1. A subsea oil over water storage tank, having one or multiple of high dynamic range, gas-liquid separators, which first receive oil well fluids, and cyclically depressurize and release free and solution gas to surface, and then expel unseparated liquids to the subsea storage tank, where the oil and water may be further separated by gravity separation, providing a means of separating stabilising crude oil.

2. A subsea separation and storage system described in claim 1, provides a means of stabilising crude oil to a vapour pressure necessary to transport at surface, even though the operation takes place in a hyperbaric subsea setting.

3. For a subsea separation and storage system described in claim 1, may be made to be a continuous flow system, as opposed to a cyclic flow system, if two or more high dynamic range gas liquid separators are employed and sequenced so one in ingesting well fluids while the other is expelling degassed fluids.

4. A subsea oil storage pre-separation system for processing of well fluids comprising a mixture of oil, gas and water, the system comprising a tank having an inner space and at least one primary separator fluidly connected to the tank to permit the mixture of oil and water to enter the tank, wherein the tank comprises a flume having an inlet for receiving the water and oil mixture, a first end with first outlet means to allow exit of oil (from the oil-water mixture), and a second end with second outlet means to allow exit of water from the oil-water mixture.

5. A system according to claim 4 wherein the flume is located in the centre of tank such that the second end is located at the bottom of the tank.

6. A system according to claim 4 or 5 wherein, the flume extends perpendicularly from the bottom of the tank so that the first end is located at a location adjacent an upper wall of the tank.

7. A system according to any one of claims 4 to 6 wherein the inlet is located adjacent the second end.

8. A system according to any one of claims 4 to 7 wherein the flume comprises a cylindrical body having first outlet means configured as a plurality of apertures surrounding the cylindrical body at the upper end, and having second outlet means configured as a plurality of apertures surrounding the cylindrical body at the lower end.

9. A system according to any one of claims 4 to 8 wherein the separator is fluidly connected to the tank via a pipe comprising a one-way valve.

10. A system according to any one of claims 4 to 9 wherein the separator is adapted to produce a pre-separation of the gas included in the well fluids exiting wells fluidly connected to the separator,

11. A system according to any one of claims 4 to 10 wherein the separator comprises a large dynamic range over which the gas-liquid interface travels within the separator.

12. A system according to claim 11 wherein the dynamic range is about 10 meters or more.

13. A system according to any one of claims 4 to 12 wherein the separator comprises upper and lower level indicators.

14. A system according to any one of claims 4 to 13 wherein the separator comprises an outlet for permitting exit of gas included in the well fluids.

15. A system according to claims 14 wherein a first pipe is fluidly connected to the outlet for delivering the gas to reach the atmosphere,

16. A system according to claim 15 wherein the first pipe comprises valve means,

17. A system according to any one of claims 4 to 16 wherein the separator comprises an inner pipe extending from a lower end of the separator, one end of the inner pipe comprises an outlet for well fluids to enter the separator.

18. A system according to claim 17 wherein the other end of the inner pipe is located outside the separator being fluidly connected to one or more wells.

19. A system according to claim 17 or 18 wherein a first control valve is located within the flow path of the inner pipe to permit controlling well fluids to enter the separator.

20. A system according to any one of claims 17 to 19 wherein the inner pipe is configured so that the outlet is located at the upper end of the dynamic range of the separator,

21. A system according to any one of claims 4 to 20 wherein there is provided a plurality of separators arranged and fluidly connected in a tandem relationship with respect each other.

22. A subsea oil storage pre-separation system for processing of well fluids comprising a mixture of oil, gas and water, the system comprising a tank having an inner space and at least one primary separator fluidly connected to the tank to permit the mixture of oil and water to enter the tank, wherein the separator comprises upper and lower level indicators defining a dynamic range over which the gas-liquid interface may travel within the separator.

23. A system according to claim 22 wherein the separator is fluidly connected to the tank via a second pipe comprising a one-way valve,

24. A system according to claim 22 or 23 wherein the separator is adapted to produce a pre-separation of the gas included in the well fluid exiting the wells.

25. A system according to any one of claims 22 to 24 wherein the separator comprises a large dynamic range, meaning the range over which the gas-liquid interface may travel within the separator.

26. A system according to claim 25 wherein the dynamic range is about 10 meters or more.

27. A system according to any one of claims 22 to 26 wherein the separator comprises an outlet for permitting exit of gas of the well fluids.

28. A system according to any one of claims 22 to 27 wherein a first pipe is fluidly connected to the outlet for delivering the gas to reach the atmosphere.

29. A system according to claim 28 wherein the first pipe comprises valve means,

30. A system according to any one of claims 22 to 29 wherein the separator comprises an inner pipe extending from a lower end of the separator, one end of the inner pipe comprises an outlet for well fluids to enter the separator.

31. A system according to claim 30 wherein the other end of the inner pipe is located outside the separator being fluidly connected to one or more wells.

32. A system according to claim 30 or 31 wherein a first control valve is located within the flow path of the inner pipe to permit controlling well fluids to enter the separator.

33. A system according to any one of claims 30 to 32 wherein the inner pipe is configured so that the outlet is located at the upper end of the dynamic range of the separator.

34. A system according to any one of claims 22 to 33 wherein the tank comprises a tank as described in any one of claims 4 to 33.
